(19) United States
(12) Patent Application Publication
(10) Pub. No.: US 2018/0069713 A1
(43) Pub. Date: Mar. 8, 2018

(54) DUAL POWER OVER ETHERNET REDUNDANCY

(71) Applicant: Aruba Networks, Inc., Sunnyvale, CA (US)

(72) Inventors: Yu Liu, Sunnyvale, CA (US); Prakash Guda, Sunnyvale, CA (US); Thomas Nguyen, Sunnyvale, CA (US)

(21) Appl. No.: 15/259,078

(22) Filed: Sep. 8, 2016

(51) Int. Cl. H04L 12/10; H02M 3/335

(52) U.S. Cl. CPC H04L 12/10; H02M 3/33507

(57) ABSTRACT

In some examples, a Powered Device (PD) having dual Power over Ethernet (PoE) redundancy comprises a first PD chip to interact with a first PoE port comprised in a first Power Sourcing Equipment (PSE), a second PD chip to interact with a second PoE port comprised in a second PSE, a first control logic module to permit the first PD chip to independently interact with the first PoE port, a second control logic module to permit the second PD chip to independently interact with the second PoE port, a first Field Effect Transistor FET to turn on/off a first diode, the first FET being controlled by the first control logic module, a second FET to turn on/off a second diode, the second FET being controlled by the second control logic module. The first and the second diodes to combine the first and the second voltages from the first and the second PSE, respectively. Furthermore, the PD comprises a first bridge diode to draw a first voltage from the first PSE upon permitted interaction by the first control logic module, a second bridge diode to draw a second voltage from the second PSE upon permitted interaction by the second control logic module and a voltage converter to input the combined voltage level from the first and the second diodes and output a lower voltage level.

### BACKGROUND

Power over Ethernet (PoE) can permit a Local Area Network (LAN) switching infrastructure to provide power to a powered device over an Ethernet cable. PoE can provide scalable, manageable power delivery to Internet Protocol (IP) telephones and may simplify IP telephony deployments. PoE may further be used to power wireless devices in locations where local power access does not exist or is impractical. While some IP telephones and wireless Access Points (AP) rely on PoE for power, PoE can further provide power to other networked-attached devices, including: video cameras, point-of-sale devices, security access control (card scanners), building automation and industrial automation.

### BRIEF DESCRIPTION OF THE DRAWINGS

FIG. 1 shows an Ethernet device, e.g. an AP receiving power via a redundant PoE connection in accordance with an example of the present disclosure.

FIG. 2 shows a Powered Device (PD) with dual PoE support according to an example of the present disclosure.

FIG. 3 is a flowchart of an example process for managing dual PoE redundancy into a PD.

FIG. 4 is a block diagram of an example machine-readable storage medium including instructions to dual PoE redundancy into a PD.

### DETAILED DESCRIPTION

Power over Ethernet (PoE) technology can enable transmission of electric power, along with data, to devices over a network cable, such as an Ethernet cable in an Ethernet network. The PoE technology can be used for powering various PoE devices, such as voice over internet protocol (VoIP) telephones, Wireless Local Area Network (WLAN) AP'S, webcams, embedded computers, and other appliances, over the Ethernet cable. As a result, a separate power supply for powering the PoE devices may not be needed. The PoE devices can be connected to communication devices, such as Ethernet switches, routers, hubs, other network switching equipment, or midspan devices.

With the introduction of new Ethernet-enabled devices expanding geometrically, the need to power these devices from standard Alternate Current (AC) power outlets can be considered in order to permit the setup of these devices. IP telephones, wireless AP, IP cameras and device servers can be examples of devices needed to have an AC power outlet nearby to plug in a Direct Current (DC) power adapter.

A PoE system can comprise an Ethernet switch and a power hub, which can supply DC power, along with a number of PoE devices, which can communicate via the switch and draw power from a power hub. The power sourcing equipment in the power hub can be referred to as a Power Sourcing Equipment (PSE), while each device that can receive the power can be referred to as a Powered Device (PD). The PSE may be integrated with the Ethernet switch, in what is known as an “end-span” configuration, or it may alternatively be located between the switch and the devices, in a “mid-span” configuration.

In some configurations, PoE can supply power to network devices over the same cabling that carries the data. PoE devices can be installed wherever structured Ethernet wiring is located, without having AC power outlets nearby. The benefits of PoE can include increased mobility for end devices, added safety (no AC power involved), and simplicity of installation, reliability, security and cost savings.

An AP can have one Ethernet port, as throughput gets higher, higher end APs can be implemented with two Ethernet ports, which can be both powered by PoE. Adding extra circuit to support both PoE capable ports can be costly and PCB space constraint. In particular, in a configuration where two PoE ports can operate, there should be isolation before a PD chip is enabled.

The solution described in the present disclosure can achieve dual PoE support on both Ethernet ports by adding load sharing control logic to meet all Power Sourcing Equipment (PSE)/Powered Device (PD) specification and achieving dual PoE isolation. In particular, the present disclosure describes a PD with a single flyback transformer where two independent PD Integrated Controller (IC) chips can be isolated by using Field Effect Transistors (FET's) and control logic to separate the low side of the connection.

In an example according to the present disclosure, it is shown a Powered Device (PD) having dual Power over Ethernet (PoE) redundancy. The PD can comprise a first PD chip to interact with a first PoE port comprised in a first Power Sourcing Equipment (PSE), a second PD chip to interact with a second PoE port comprised in a second PSE, a first control logic module to permit the first PD chip to independently interact with the first PoE port, a second control logic module to permit the second PD chip to independently interact with the second PoE port, a first and a second (Field Effect Transistor) FET's to on-off switch a first and a second diodes current flowing through the PD and hence, the first and the second FET's being controlled by the first and the second control logic modules, a first bridge diode to draw a first voltage from the first PSE upon permitted interaction by the first control logic module between the first PD chip and the first PoE port, a second bridge diode to draw a second voltage from the second PSE upon permitted interaction by the second control logic module between the second PD chip and the second PoE port, a first and a second diode to combine the first and the second voltages from the first and the second PSE's, respectively and a voltage converter to draw the combined voltage from the first and second diodes and output a lower voltage level.

In another example according to the present disclosure it is described a method for managing redundant power into a Powered Device (PD). The method comprises the PD detecting a first PoE port comprised in a first Power Sourcing Equipment (PSE) by a first PD chip, the PD detecting a second PoE port comprised in a second PSE by a second PD chip, the PD causing communication between the first PD chip and the first PoE port, by a first control logic module, the PD causing communication between the second PD chip and the second PoE port, by a second control logic module, the PD receiving a first voltage level delivered by the first PSE upon allowed communication by the first control logic module, the first voltage level received by a first bridge diode, the PD receiving a second voltage level delivered by the second PSE upon allowed communication by the second control logic module, the second voltage level received by a second bridge diode and the PD combining, by a first and a second diodes, the first and the second voltage levels delivered by the first and the second PSE, respectively. Furthermore, the PD converting, by a voltage converter, a combined voltage of the first and the second voltages into a lower single voltage level. Moreover, the first PD chip can be isolated from the second PD chip and vice versa by a first and a second FET's and the first and the second diodes can be turned on/off by the first and the second FET's, respectively.

In another example according to the present disclosure a non-transitory machine-readable storage medium may be encoded with instructions to manage dual PoE redundancy into a PD. The non-transitory machine-readable storage medium may comprise instructions to detect a first PoE port comprised in a first PSE by a first PD chip, instructions to detect a second PoE port comprised in a second PSE by a second PD chip, instructions to cause communication between the first PD chip and the first PoE port, by a first control logic module, instructions to cause communication between the second PD chip and the second PoE port, by a second control logic module, instructions to receive a first voltage level delivered by the first PSE upon allowed communication by the first control logic module, the first voltage level received by a first bridge diode, instructions to receive a second voltage level delivered by the second PSE upon allowed communication by the second control logic module, the second voltage level received by a second bridge diode, instructions to obtain a combined voltage level, by a first and a second diodes activated by a first and a second FET's and instructions to convert, by a voltage converter, the combined voltage level from the first and the second diodes into a lower voltage level. The first and the second FET's are controlled by the first and the second control logic modules, respectively and the combined voltage level is the first voltage level, the second voltage level or a combination of the first and the second voltage levels.

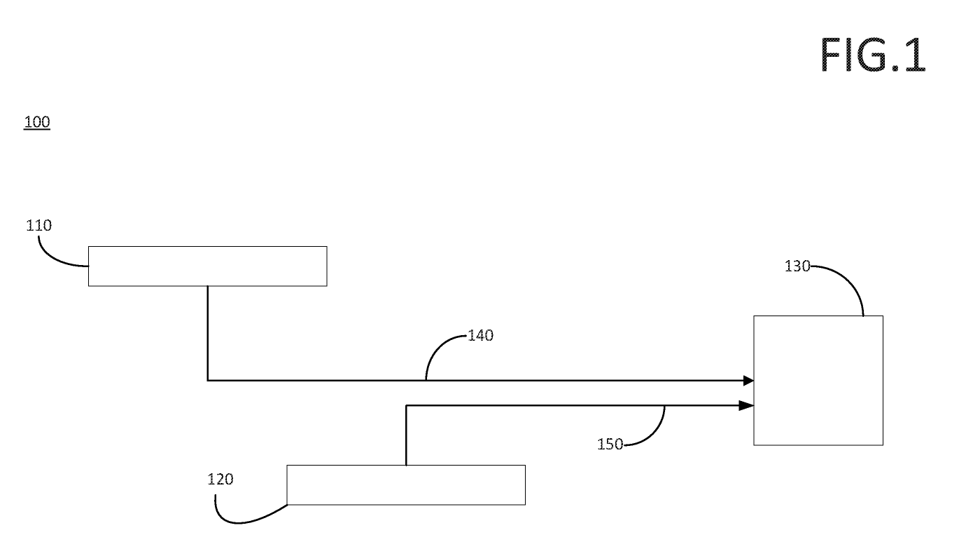

FIG. 1 shows a PD having dual Power over Ethernet (PoE) redundancy according to the solution proposed in the present disclosure. This PD can be e.g. an AP 130 receiving power via redundant PoE connections in accordance with an example of to the present disclosure. FIG. 1 is a simplified depiction of an AP 130 that receives power via redundant Power-Over-Ethernet connections in accordance with an example of the present disclosure. The device associated with the redundant Power-Over-Ethernet connections could be any type of network device. A first PSE 110 comprising an Ethernet switch can supply power via a first Unshielded/Shielded Twisted Pair (UTP/STP) cable 140. The Power-Over-Ethernet power source could be, as desired, separated from the Ethernet switch 110. As shown, the first Ethernet switch 110 and a second PSE comprising an Ethernet switch 120 each can supply power to the AP 130 in accordance with this example of the present disclosure. The PSE may be integrated with the Ethernet switch, in what it can be known as an “end-span” configuration, or it may alternatively be located between the switch and the devices, in a “mid-span” configuration. Power from the first switch 110 can be supplied via the first UTP/STP cable 140 and power from the second switch 120 can be supplied via a second UTP/STP cable 150. If power is unavailable via one of the cables UTP/STP, the other cable UTP/STP can supply power to the AP 130.

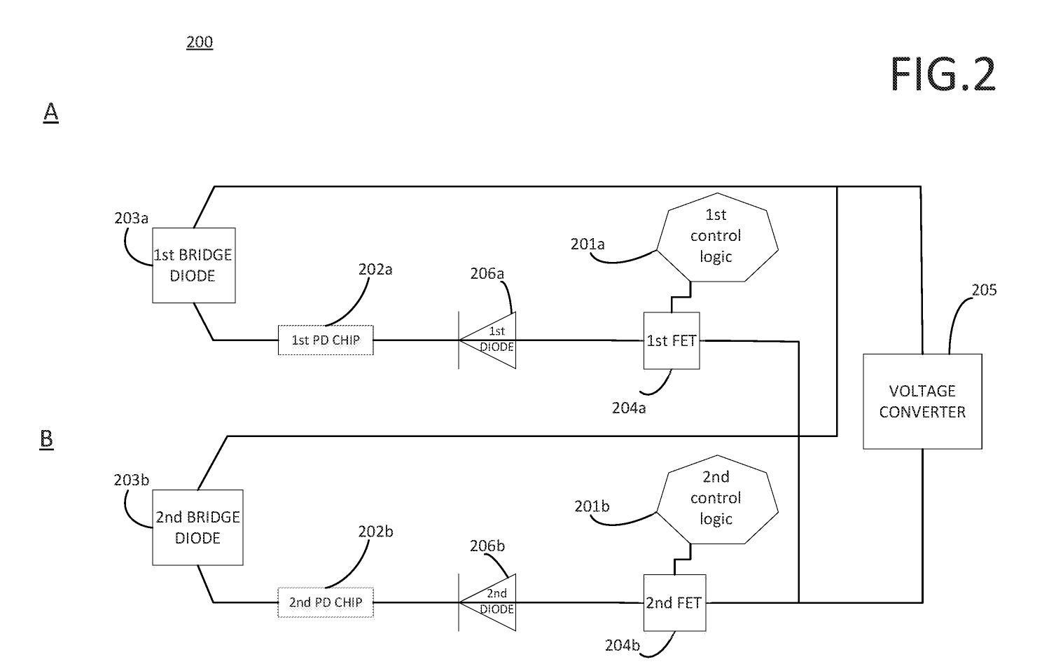

FIG. 2 shows a PD 200 with dual PoE support according to an example of the present disclosure. As it can be seen in FIG. 2, the PD 200 comprises a first circuit A associated with a first PSE end-span/mid-span that comprises a first PoE port and a second circuit B associated with a second PSE end-span/mid-span that comprises a second PoE port. The first circuit A can be on/off switched by a first FET 204a that controls current flowing through the first circuit A by activating a first diode 206a. The first FET 204a can permit isolation between the first circuit A and the second circuit B. A first control logic 201a module can activate the first FET 204a. The first control logic 201a module can allow circuit A of the PD 200 to independently communicate with the first PSE before power delivering is shared with other sources/devices.

Furthermore, the PD 200 further comprises a first PD integrated circuit (IC) or a first PD chip 202a. The first PD chip 202a main interact with the first PSE at the switch/network device side on analog level for detection, classification, and in rush control of inrush current before full power can be drawn from the first PSE into the PD 200 via circuit A. Inrush current can be defined as the maximum instantaneous input current drawn by an electrical device when it is first turned on. The PD 200 can comprise a first bridge diode 203a. The first bridge diode 203a can permit different polarity for different power delivering schemes as e.g. Medium Dependent Interface (MDI) and Medium Dependent Interface Crossover (MDI-X) power delivering scheme. A MDI describes the interface (both physical and electrical) in a network device from a physical layer implementation to the physical medium used to carry the transmission. Ethernet over twisted pair defines MDI-X interface. The first bridge diode 203a can to draw current from an Ethernet cable linking the first PSE with the PD 200. The Ethernet cable can comprise two data/signal pairs where each pair comprises two pins, i.e. the Ethernet cable can comprise pins 1 to 8. According to a present example, the first PSE can apply positive voltage to pins 4 and 5 and negative voltage to pins 7 and 8. In another examples, different pin selection can be determined. Hence, the first bridge diode 203a can allow different polarities for different pairs of the Ethernet cable in order to permit electrical coupling between the PD 200 and the first PSE.

The circuit B of the PD 200 shown in FIG. 2 comprises circuit elements previously mentioned in a redundant fashion with respect to the circuit A. Similarly, the circuit A comprises circuit elements in a redundant fashion with respect to the circuit elements comprises in circuit B. Hence, the circuit B further comprises a second control logic 201b module, the second control logic 201b module can configure the second FET 204b to control current flowing through circuit B by activating a diode 206b and hence, insolating circuit B from circuit A. Circuit B further comprises a second bridge diode 203b that similarly to the first bridge can permit different polarity for different power delivering schemes, and a second PD IC chip 202b to interact with the second PSE (switch side) on analog level for detection, classification, and in rush control of inrush current before full power can be drawn from the second PSE into the PD 200 via circuit B.

The second bridge diode 203b can to draw current from an Ethernet cable linking the second PSE with the PD 200. The Ethernet cable can comprise two data/signal pairs where each pair comprises two pins, i.e. the Ethernet cable can comprise pins 1 to 8. According to a present example, the second PSE can apply positive voltage to pins 1 and 2 and negative voltage to pins 3 and 6. In another examples, different pin selection can be determined. Hence, the second bridge diode 203b can allow different polarities for different pairs of the Ethernet cable in order to permit electrical coupling between the PD 200 and the second PSE.

The first control logic 201a module and the second control logic 201b module can be interconnected via status lines that may permit the synchronization of both control logics during functioning. A control signal related to the activation of diodes 206a and 206b can be transmitted between the first control logic 201a module and the second control logic 201b module. Hence, circuits A and B can be both active and synchronized via the status lines permitting both circuits to simultaneously operate to draw current from the first and the second PSE's. If a fail over occurs in PD 200 in circuit A or circuit B, the control logic of the failed circuit can communicate via the status lines with the control logic of the non-failed circuit. The non-failed circuit can keep operating under a possible fail-over for being in an active standby due to the redundant characteristics of the present solution without having to perform a reboot of the PD 200 or any other recovery procedure after fail-over.

FIG. 2 further comprises the voltage converter DC-DC 205 associated with both circuits, circuit A and circuit B. The converter 205 can comprise a transitional flyback IC and the flyback transformer. The converter 205 can convert a combined input voltage from circuits A and B from the first and second PSE's or a non-combined voltage from circuit A or from circuit B due to fail-over. The converter 205 can convert from e.g. a combined input voltage equal to 57V DC to a lower voltage e.g. 5V. This lower voltage can be used by the rest of the system digital circuit.

The first control logic 201a module and the second control logic 201b module can manage the activation of the circuit A and the circuit B in order to permit isolation between the first PD chip 202a and the second PD chip 202b. The control logics can independently interact with the PSE ports before power is drawn into the PD 200. The isolation of the first and second PD chip's 202a and 202b can be achieved by taking use of first and second FET's 204a and 204b activated by the control logics and that can switch the control current flowing. The PD 200 according to the present disclosure can permit that in response to the first or the second PSE fails to deliver current, the PD 200 can keep relying on the non-failed PSE without requiring a reboot of the PD 200 due to its redundant characteristics. As both circuits A and B can be actively operating during performance of PD 200 the fail over does not affect PD 200. The control logic from the failed circuit (circuit A or circuit B) may communicate the failover to the control logic of the non-failed circuit that can be in an active standby. The non-failed circuit can keep operative independently of the failover and/or the failover signal sent from the failed circuit achieving a redundant performance.

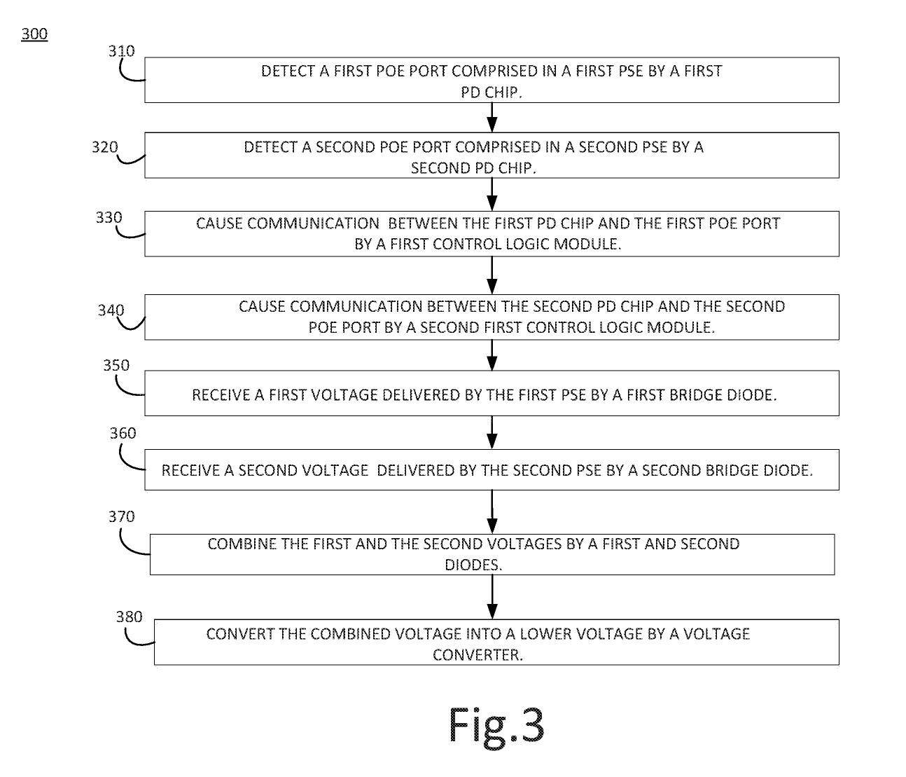

Turning now to FIG. 3, FIG. 3 shows a flowchart 300 of an example process for managing dual Power over Ethernet (PoE) redundancy according to the present disclosure. The example process can be performed by e.g. the PD 200. Flowchart 300 comprises block 310 to detect a first PoE port comprised in a first PSE by a first PD chip (component 202a in FIG. 2) and block 320 to detect a second PoE port in a second PSE by a second PD chip (component 202b in FIG. 2). The first and the second PSE can be e.g. devices 110 and 120 previously described in FIG. 1. The PD IC'S main function can be to interact with the first and the second PSE's at the switch/network device side on analog level for detection, classification, and in rush control of inrush current before full power can be drawn from the first and the second PSE's into the PD.

Furthermore, flowchart 300 comprises block 330 to cause communication between the first PD chip 202a and the first PoE port by a first control logic module (component 201a in FIG. 2) and block 340 to cause communication between the second PD chip 202b and the second PoE by a second control logic module (component 201b in FIG. 2).

Flowchart 300 further comprises, block 350 to receive a first voltage delivered by the first PSE upon allowed communication performed in block 330 by the first control logic module 201a. The first voltage provided by the first PSE can be drawn by the first bridge diode (component 203a in FIG. 2). Block 360 to receive a second voltage delivered by the second PSE upon allowed communication by the second control logic module 201b implemented by block 340. The second voltage provided by the second PSE can be drawn by the second bridge diode (component 203b in FIG. 2).

The diagram 300 can further comprise block 370 to combine the first and the second voltage levels by the first and the second diodes (components 206a, 206b in FIG. 2) and by e.g. performing an OR's function. The first and the second diodes 206a, 206b can be turned on/off by a first and second FET's (components 204a and 204b in FIG. 2), respectively. The first and second FET's can be controlled by the first control logic module 201a and the second control logic module 201b. The combined voltage level can be processed by the voltage converter (component 205 in FIG. 2) under block 380.

Block 380 can be executed by the voltage converter 205 that can draw the combined voltage level from the first and the second diodes 206a, 206b and convert or adapt the combined voltage level into a lower voltage level, such as 5V by performing block 380.

Hence, a PD functioning according to blocks 310 to 380 and comprising the aforementioned components shows in FIG. 2 can permit that in response to one of the PSE's failing to deliver current, the PD can keep relying on the non-failed PSE without requiring a reboot of the PD due to its redundant characteristics. As both redundant circuits comprised in the PD are actively operative during performance of the PD a fail over does not affect the PD. In some examples, the control logic from the failed circuit may transmit a failover signal to the non-failed circuit that can be in an active standby. The non-failed circuit can keep operative independently of the failover and/or the failover signal from the failed circuit.

Diagram 300 can further comprise a block to detect and classify the current from the first and the second PoE ports by the first PD chip and the second PD chips, respectively. Diagram 300 can comprise a further block to allow current to flow towards the first PD chip by the first diode and can comprise a block to allow current flow towards the second PD chip by the second diode.

Diagram 300 can further comprise a block to control turn-on inrush current from the first PoE by the first PD chip and a block to control turn-on inrush current from the second PoE by the second PD chip. Diagram 300 can comprise a further block to avoid a fail-over upon detection of a power supply failure from the first or the second PSE by the first and the second control logic modules, respectively.

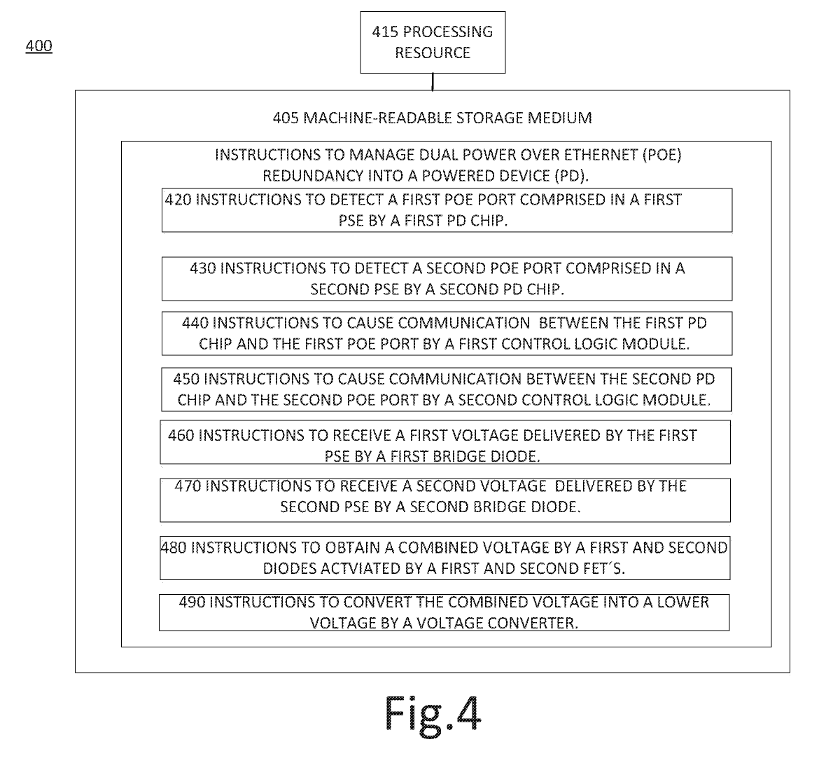

Turning now to FIG. 4, FIG. 4 shows a block diagram 400 of an example of a machine-readable storage medium 405 according to an example of the present disclosure to manage dual power over Ethernet (PoE) redundancy into a powered device (PD). The storage medium 405 can include instructions executable by a processing resource 415 that can cause the PD to manage dual PoE redundancy. In particular, the storage medium 405 can comprise instructions 420 to detect a first PoE port comprised in a first PSE by a first PD chip and instructions 430 to detect a second PoE port comprised in a second PSE by a second PD chip. The first PD chip can interact with a first PoE port comprised in a first Power Sourcing Equipment (PSE) by executing instructions 420. The second PD chip can interact with a second PoE port comprised in a second PSE by executing instructions 430.

The storage medium 405 can comprise instructions 440 to cause communication between the first PD chip and the first PoE port by a first control logic module and instructions 450 to cause communication between the second PD chip and the second PoE port by a second control logic module. The first control logic module can allow the first PD chip to independently communicate with the first PoE port comprised within the first PSE before power delivering is shared with other sources/devices by executing instructions 440. The second control logic module can allow the second PD chip to independently communicate with the second PoE port comprised in the second PSE before power delivering is shared with other sources/devices by executing instructions 450.

The storage medium 405 can comprise instructions 460 to receive a first voltage delivered by the first PSE by a first bridge diode and instructions 470 to receive a second voltage delivered by the second PSE by a second bridge diode. The first and the second bridge diodes can permit different polarity for different power delivering schemes as e.g. Medium Dependent Interface (MDI) and Medium Dependent Interface Crossover (MDI-X) power delivering scheme. The first bridge diode can draw current from an Ethernet cable linking the first PSE with the PD by executing instructions 460. The second bridge diode can draw current from an Ethernet cable linking the second PSE with the PD by executing instructions 470.

The storage medium 405 can comprise instructions 480 to obtain a combined voltage level by a first and second diodes. The combined voltage level can be the first voltage level, the second voltage level or a combination of the first and the second voltage levels.

The first and the second voltage levels can be combined e.g. by performing an OR's function when executing instructions 480. Instructions 480 can further comprise instructions to turn on/off the first and the second diodes by a first and second FET's, respectively. Instructions 480 can comprise instructions to control the first and the second FET's by the first and the second control logic modules.

The storage medium 405 can comprise instructions 490 to convert the combined voltage into a lower voltage by a voltage converter. The converter can be a DC-DC converter and can comprise a transitional flyback IC and a flyback transformer. The converter can convert an input voltage e.g. a combined input voltage equal to 57V DC to a lower voltage e.g. 5V. This lower voltage can be used by the rest of the system digital circuit. The voltage converter can convert the combined voltage into a lower voltage by executing instructions 490.

The storage medium 405 can comprise instructions to control turn-on inrush current from the first PoE by the first PD chip and instructions to control turn-on inrush current from the second PoE by the second PD chip. Inrush current can be defined as the maximum instantaneous input current drawn by an electrical device when it is first turned on. When executing the aforementioned instructions, the first PD chip can interact with the first PSE at the switch/network device side on analog level for detection, classification, and in rush control of inrush current before full power can be drawn from the first PSE into the PD and the second PD chip can interact with the second PSE at the switch/network device side on analog level for detection, classification, and in rush control of inrush current before full power can be drawn from the second PSE into the PD. Although examples for the PD with dual PoE power redundancy have been described in language specific to structural features and/or methods, it is to be understood that the appended claims are not necessarily limited to the specific features or methods described. Rather, the specific features and methods are disclosed as exemplary implementations for Power over Ethernet (PoE) communication systems.

What is claimed is:

1. A Powered Device (PD) having dual Power over Ethernet (PoE) redundancy, the PD comprising:
a first PD chip to interact with a first PoE port comprised in a first Power Sourcing Equipment (PSE);
a second PD chip to interact with a second PoE port comprised in a second PSE;
a first control logic module to permit the first PD chip to independently interact with the first PoE port;
a second control logic module to permit the second PD chip to independently interact with the second PoE port;
a first Field Effect Transistor (FET) to turn on/off a first diode, the first FET being controlled by the first control logic module;
a second FET to turn on/off a second diode, the second FET being controlled by the second control logic module,
wherein the first and the second diodes combine the first and the second voltages from the first and the second PSE, respectively;
a first bridge diode to draw a first voltage from the first PSE upon permitted interaction by the first control logic module;
a second bridge diode to draw a second voltage from the second PSE upon permitted interaction by the second control logic module;
and
a voltage converter to:
input the combined voltage level from the first and the second diodes; and
output a lower voltage level.

2. The PD of claim 1, wherein:
the first diode to allow current to flow towards the first PD chip; and
the second diode to allow current to flow towards the second PD chip.

3. The PD of claim 1, wherein the first and the second PD chips to control turn-on inrush current from the first and the second PoE ports, respectively.

4. The PD of claim 1, wherein the first and the second PD chips to detect and classify current from the first and the second PoE ports, respectively.

5. The PD of claim 1, wherein the first PSE is a midspan device and the second PSE is an endspan device or the first PSE and the second PSE are the same type of device.

6. The PD of claim 1, wherein the powered device is an access point.

7. The PD of claim 1, wherein the first and the second control logic modules to avoid a fail-over upon detection of power supply failure from the first or the second PSE, respectively.

8. The PD of claim 1, wherein the voltage converter comprises:
a flyback transformer to convert the drawn voltage to the lower first and second voltage levels; and
a transitional flyback integrated circuit (IC) performing as a switch regulator of the flyback transformer.

9. A method for managing dual Power over Ethernet (PoE) redundancy into a Powered Device (PD), the method comprising:
the PD detecting a first PoE port comprised in a first Power Sourcing Equipment (PSE) by a first PD chip;
the PD detecting a second PoE port comprised in a second PSE by a second PD chip;
the PD causing communication between the first PD chip and the first PoE port, by a first control logic module;
the PD causing communication between the second PD chip and the second PoE port, by a second control logic module;
the PD receiving a first voltage level delivered by the first PSE upon allowed communication by the first control logic module, the first voltage level received by a first bridge diode;
the PD receiving a second voltage level delivered by the second PSE upon allowed communication by the second control logic module, the second voltage level received by a second bridge diode;
the PD combining, by a first and a second diodes activated by a first and a second FET'S, the first and the second voltage levels, respectively; and
the PD converting, by a voltage converter, the combined voltage level from the first and the second diodes into a lower voltage level;

10. The method of claim 9, further comprising:
the PD controlling turn-on inrush current from the first PoE by the first PD chip; and
the PD controlling turn-on inrush current from the second PoE by the second PD chip.

11. The method of claim 9, further comprising the PD avoiding a fail-over upon detection of a power supply failure from the first or the second PSE by the first and the second control logic modules, respectively.

12. The method of claim 9, further comprising the PD converting the first and the second voltage levels into the first and second lower voltage levels by a flyback transformer comprised within the voltage converted.

13. The method of claim 9, further comprising the PD adapting the combined lower voltage level by a transitional flyback integrated circuit (IC) performing as a switch regulator of the flyback transformer.

14. A non-transitory machine-readable storage medium encoded with instructions executable by a processor to manage dual Power over Ethernet (PoE) redundancy into a Powered Device (PD), the machine-readable storage medium comprising:
instructions to detect a first PoE port comprised in a first Power Sourcing Equipment (PSE) by a first PD chip;
instructions to detect a second PoE port comprised in a second PSE by a second PD chip;
instructions to cause communication between the first PD chip and the first PoE port, by a first control logic module;
instructions to cause communication between the second PD chip and the second PoE port, by a second control logic module;
instructions to receive a first voltage level delivered by the first PSE upon allowed communication by the first control logic module, the first voltage level received by a first bridge diode;
instructions to receive a second voltage level delivered by the second PSE upon allowed communication by the second control logic module, the second voltage level received by a second bridge diode;
instructions to obtain a combined voltage level, by a first and a second diodes activated by a first and a second FET'S; and
instructions to convert, by a voltage converter, the combined voltage level from the first and the second diodes into a lower voltage level,
wherein the first and the second FET'S are controlled by the first and the second control logic modules, respectively, and
wherein the combined voltage level is the first voltage level, the second voltage level or a combination of the first and the second voltage levels.

15. The non-transitory machine-readable storage medium of claim 14, further comprising instructions to:
control turn-on inrush current from the first PoE by the first PD chip; and
control turn-on inrush current from the second PoE by the second PD chip.
